(19) United States
(12) Patent Application Publication
(10) Pub. No.: US 2019/0149998 A1
(43) Pub. Date: May 16, 2019

(54) METHOD AND APPARATUS FOR MANAGING NETWORK SLICE

(71) Applicant: HUAWEI TECHNOLOGIES CO., LTD., SHENZHEN (CN)

(72) Inventors: Shuigen YANG, Shanghai (CN); Wei TAN, Shanghai (CN); Wei ZHANG, Shanghai (CN)

(21) Appl. No.: 16/226,097

(22) Filed: Dec. 19, 2018

Related U.S. Application Data
(63) Continuation of application No. PCT/CN2017/087607, filed on Jun. 8, 2017.

(30) Foreign Application Priority Data
Jun. 30, 2016 (CN) 201610514001.7

(51) Int. Cl. H04W 16/04

(52) U.S. Cl. CPC H04W 16/04

(57) ABSTRACT

Embodiments of the application provide a method and an apparatus for managing a network slice. A first update request message sent by a second network device is received by a first network device. The first update request message carries network slice requirement information. The network slice requirement information is used to indicate that a network resource of a first network slice needs to be updated to a first network resource. A second network resource that can be actually provided for the first network slice is determined by the first network device based on the first update request message. An update acknowledgement message is sent by the first network device to the second network device. The update acknowledgement message is used to instruct to update the network resource of the first network slice based on the second network resource.

### CROSS-REFERENCE TO RELATED APPLICATIONS

This application is a continuation of International Application No. PCT/CN2017/087607, filed on Jun. 8, 2017, which claims priority to Chinese Patent Application No. 201610514001.7, filed on Jun. 30, 2016. The disclosures of the aforementioned applications are hereby incorporated by reference in their entireties.

### TECHNICAL FIELD

Embodiments of this application relate to the communications field, and more specifically, to a method and an apparatus for managing a network slice in the communications field.

### BACKGROUND

With development of communications technologies, a communications network supports more diverse service requirements and scenarios, and the communications network is further abstracted into network slicing (NS) based on a logical function. The network slicing is a logical network functional combination that supports a communication service requirement of a particular case. For example, in a 5th Generation (5G) network, an enhanced mobile broadband (eMBB) network slice, a massive machine type communication (mMTC) network slice, an ultra reliable machine type communication (uMTC) network slice, and the like may be customized based on a service requirement.

However, an existing network management solution does not support management of a network slice, and a plurality of network slices in a network are independent and mutually equivalent. Therefore, a network resource of each of the plurality of network slices needs to be independently managed. In management of a network slice, how to implement updating of the network slice is a problem that urgently needs to be resolved.

### SUMMARY

In view of the above, embodiments of this application provide a method and an apparatus for managing a network slice, so that a network slice can be updated based on an actual network status, thereby properly using a network resource.

In at least one embodiment, a method for managing a network slice is provided. The method includes: receiving, by a first network device, a first update request message sent by a second network device, where the first update request message carries network slice requirement information, and the network slice requirement information is used to indicate that a network resource of a first network slice needs to be updated to a first network resource; determining, by the first network device based on the first update request message, a second network resource that can be actually provided for the first network slice; and sending, by the first network device, an update acknowledgement message to the second network device, where the update acknowledgement message is used to instruct to update the network resource of the first network slice based on the second network resource.

In at least one embodiment, the first network resource is a network resource needed for the first network slice, and the second network resource is a network resource that can be provided for the first network slice based on an actual network status. The first network resource may be the same as or different from the second network resource. If the first network resource is different from the second network resource, the second network resource is included in the first network resource. In addition, the network slice requirement information may carry only some information that changes compared with an original network resource of the first network slice, or may carry all network resources for the first network slice. This is not limited in an embodiment of this application.

In at least one embodiment of this application, the first network device receives the update request message sent by the second network device, and determines, based on the network slice requirement information carried in the update request message and based on the actual network status, the network resource that can be actually provided for the requested first network slice. After the first network device orchestrates the network resource that can be actually provided, and after configuring, by using a third network device, the network resource that can be actually provided, the first network device sends the update acknowledgement message to the second network device. The second network device updates the network resource of the first network slice based on the update acknowledgement message. To be specific, the second network device updates the network resource of the first network slice to the foregoing network resource that can be actually provided.

Therefore, in the method for managing a network slice in at least one embodiment of this application, the first network device determines, based on the network slice requirement information sent by the second network device and the actual network status, the network resource that can be actually provided for the first network slice, so that a network slice can be updated based on the actual network status, thereby properly using the network resource.

In at least one embodiment, the determining, by the first network device based on the first update request message, a second network resource that can be actually provided for the first network slice includes: determining, by the first network device, the first network resource as the second network resource when the first network resource is included in a third network resource currently occupied by the first network slice.

In at least one embodiment, the determining, by the first network device based on the first update request message, a second network resource that can be actually provided for the first network slice includes: sending, by the first network device, a reservation request message to a third network device when a third network resource currently occupied by the first network slice is included in the first network resource and it is determined that there is no available network resource, where the reservation request message carries information about the first network resource; receiving, by the first network device, a reservation acknowledgement message sent by the third network device based on the reservation request message, where the reservation acknowledgement message carries information about the second network resource; and determining, by the first network device, the second network resource based on the reservation acknowledgement message.

In at least one embodiment, updating of a network slice includes two cases: diminishing and expanding the network slice. For a case of requesting to diminish the network slice, network resources are sufficient, and the first network resource is the same as the second network resource. For a case of requesting to expanding the network slice, it needs to be determined whether there is an available network resource, and a network resource is allocated to the first network slice based on an actual case. If there is no available network resource, the first network device needs to send a resource reservation message to the third network device to request a corresponding network resource. In this case, the first network resource may be the same as or different from the second network resource.

In at least one embodiment, the determining, by the first network device based on the first update request message, a second network resource that can be actually provided for the first network slice includes: determining, by the first network device, the second network resource based on a plurality of update request messages, where the plurality of update request messages are used to request to update network resources of a plurality of network slices, the plurality of update request messages include the first update request message, and the plurality of network slices include the first network slice.

In at least one embodiment, the first network device may receive the plurality of update request messages at a same time, for updating the network resources of the plurality of network slices. In this case, the first network device needs to orchestrate available network resources, to meet requirements of the plurality of network slices as much as possible. The orchestration herein specifically refers to determining, for each network slice, a network resource that can be actually provided.

In at least one embodiment, before the sending, by the first network device, an update acknowledgement message to the second network device, the method further includes: sending, by the first network device, a configuration request message to the third network device, where the configuration request message is used to request to configure the second network resource; and receiving, by the first network device, a configuration acknowledgement message sent by the third network device based on the configuration request message.

In at least one embodiment, the configuration request message is used to request the third network device to configure an association relationship between a network function of the first network slice and the second network resource. In at least one embodiment, an interface between network functions, a key performance indicator KPI requirement, and the like may be configured.

In at least one embodiment, before the sending, by the first network device, a configuration request message to the third network device, the method further includes: sending, by the first network device, a resource acknowledgement message to the second network device, where the resource acknowledgement message carries the information about the second network resource; and receiving, by the first network device, a resource accept message sent by the second network device based on the resource acknowledgement message, where the resource accept message is used to indicate that updating of the network resource of the first network slice to the second network resource is accepted.

In at least one embodiment, after the first network device determines the second network resource provided for the first network slice, if the second network resource is different from the first network resource requested by the second network device, the first network device may first send the resource acknowledgement message to the second network device, to determine whether the second network device accepts the second network resource, and then configure the second network resource if the second network device accepts the second network resource.

This can avoid a case in which the second network device does not accept the network resource allocated by the first network device to the second network device after the network resource is configured, thereby reducing signaling overheads, and avoiding unnecessary network resource occupancy.

In at least one embodiment, another method for managing a network slice is provided. The method includes: determining, by a second network device, network slice requirement information, where the network slice requirement information is used to indicate that a network resource of a first network slice needs to be updated to a first network resource; sending, by the second network device, a first update request message to a first network device, where the first update request message carries the network slice requirement information; receiving, by the second network device, an update acknowledgement message sent by the first network device based on the first update request message, where the update acknowledgement message is used to instruct to update the network resource of the first network slice based on the second network resource; and updating, by the second network device, the network resource of the first network slice to the second network resource based on the update acknowledgement message.

In at least one embodiment, the first network device receives the update request message sent by the second network device, and determines, based on the network slice requirement information carried in the update request message and based on an actual network status, a network resource that can be actually provided for the requested first network slice. After the first network device orchestrates the network resource that can be actually provided, and after configuring, by using a third network device, the network resource that can be actually provided, the first network device sends the update acknowledgement message to the second network device. The second network device updates the network resource of the first network slice based on the update acknowledgement message. To be specific, the second network device updates the network resource of the first network slice to the foregoing network resource that can be actually provided.

Therefore, in the method for managing a network slice in at least one embodiment of this application, the first network device determines, based on the network slice requirement information sent by the second network device and the actual network status, the network resource that can be actually provided for the first network slice, and the second network device updates the network resource of the first network slice based on a determining result of the first network device, so that a network slice can be updated based on the actual network status, thereby properly using the network resource.

In at least one embodiment, the determining, by a second network device, network slice requirement information includes: receiving, by the second network device, a second update request message, where the second update request message carries service requirement information of a user; and determining, by the second network device, the network slice requirement information based on the service requirement information.

In at least one embodiment, the determining, by a second network device, network slice requirement information includes: receiving, by the second network device, a third update request message sent by a third network device, where the third update request message carries the network slice requirement information; and determining, by the second network device, the network slice requirement information based on the third update request message.

In at least one embodiment, after the sending, by the second network device, a first update request message to a first network device and before the updating, by the second network device, the network resource of the first network slice to the second network resource based on the update acknowledgement message, the method further includes: receiving, by the second network device, a resource acknowledgement message sent by the first network device, where the resource acknowledgement message carries information about the second network resource; and sending, by the second network device, a resource accept message to the first network device if the second network device determines to accept updating of the network resource of the first network slice to the second network resource, where the resource accept message is used to indicate that updating of the network resource of the first network slice to the second network resource is accepted.

This can avoid a case in which the second network device does not accept the network resource allocated by the first network device to the second network device after the network resource is configured, thereby reducing signaling overheads, and avoiding unnecessary network resource occupancy.

In at least one embodiment, after the updating, by the second network device, the network resource of the first network slice based on the update acknowledgement message, the method further includes: sending, by the second network device, information about the first network slice to a fourth network device, where the information includes the information about the second network resource.

The fourth network device herein may be construed as a device with a network management function. The fourth network device may perform corresponding backup based on the received information about the updated first network slice, thereby facilitating network management.

In at least one embodiment, another method for managing a network slice is provided. The method includes: receiving, by a third network device, a reservation request message sent by a first network device, where the reservation request message carries information about a first network resource for a first network slice; reserving, by the third network device, a second network resource based on the reservation request message; and sending, by the third network device, a reservation acknowledgement message to the first network device, where the reservation acknowledgement message carries information about the second network resource and is used to update a network resource of the first network slice to the second network resource.

Therefore, in the method for managing a network slice in at least one embodiment of this application, the third network device reserves, based on an actual network status, a network resource that can be actually provided by the first network device for the first network slice, so that a network slice can be updated based on the actual network status, thereby properly using the network resource.

In at least one embodiment, after the sending, by the third network device, a reservation acknowledgement message to the first network device, the method further includes: receiving, by the third network device, a configuration request message sent by the first network device, where the configuration request message carries the information about the second network resource; configuring, by the third network device, an association relationship between a network function of the first network slice and the second network resource based on the configuration request message; and sending, by the third network device, a configuration acknowledgement message to the first network device.

In at least one embodiment, after the sending, by the third network device, a reservation acknowledgement message to the first network device, the method further includes: receiving, by the third network device, a release request message sent by the first network device, where the release request message is used to request to release the second network resource; releasing, by the third network device, the second network resource based on the release request message; and sending, by the third network device, a release acknowledgement message to the first network device.

In at least one embodiment of this application, the second network resource is configured if the second network device accepts the second network resource allocated by the first network device to the second network device, and the second network resource is directly released if the second network device does not accept the second network resource allocated by the first network device to the second network device. This can avoid a case in which the second network device does not accept the network resource allocated by the first network device to the second network device after the network resource is configured, thereby reducing signaling overheads, and avoiding unnecessary network resource occupancy.

In at least one embodiment, after the sending, by the third network device, a reservation acknowledgement message to the first network device, the method further includes: updating, by the third network device, information about the first network slice, where the information includes the information about the second network resource.

In at least one embodiment, another method for managing a network slice is provided. The method includes: determining, by a second network device, network slice requirement information, where the network slice requirement information is used to indicate that a network resource of a first network slice needs to be updated to a first network resource; determining, by the second network device based on the network slice requirement information, a second network resource that can be actually provided for the first network slice; and updating, by the second network device, the network resource of the first network slice to the second network resource.

It should be understood that, in at least one embodiment of this application, the second network device can have functions of both the first network device and the third network device described above. After determining the second network resource that can be actually provided for the first network slice, the second network device directly updates the network resource of the first network slice.

In at least one embodiment, the determining, by a second network device, network slice requirement information may include: receiving the network slice requirement information sent by another device or determining the network slice requirement information internally. This is not limited in at least one embodiment of this application.

In at least one embodiment, an apparatus for managing a network slice is provided. The apparatus is configured to perform methods as described herein. In at least one embodiment, the apparatus includes units configured to perform the methods as described herein.

In at least one embodiment, an apparatus for managing a network slice is provided. The apparatus includes: a transceiver, a memory, a processor, and a bus system. The transceiver, the memory, and the processor are connected to each other by using the bus system. The memory is configured to store one or more instructions. The processor is configured to execute the one or more instructions stored in the memory to control the transceiver to receive a signal and/or send a signal. In addition, when the processor executes the instruction stored in the memory, the execution causes the processor to perform the methods as described herein.

According to a tenth aspect, an apparatus for managing a network slice is provided. The apparatus includes: a transceiver, a memory, a processor, and a bus system. The transceiver, the memory, and the processor are connected to each other by using the bus system. The memory is configured to store an instruction. The processor is configured to execute the instruction stored in the memory to control the transceiver to receive a signal and/or send a signal. In addition, when the processor executes the instruction stored in the memory, the execution causes the processor to perform the method according to any one of the third aspect or the possible implementations of the third aspect.

In at least one embodiment, a system for managing a network slice is provided. The system includes the apparatus as described herein.

In at least one embodiment, a computer readable medium is provided. The computer readable medium is configured to store a computer program. The computer program includes one or more instructions for performing the methods as described herein.

### BRIEF DESCRIPTION OF DRAWINGS

FIG. 1 is a schematic diagram of a network management architecture to which an embodiment of this application is applied;

FIG. 2 is a schematic diagram of another network management architecture to which an embodiment of this application is applied;

FIG. 3 is a schematic flowchart of a method for managing a network slice according to an embodiment of this application;

FIG. 4 is a schematic flowchart of another method for managing a network slice according to an embodiment of this application;

FIG. 5 is a schematic flowchart of another method for managing a network slice according to an embodiment of this application;

FIG. 6 is a schematic flowchart of another method for managing a network slice according to an embodiment of this application;

FIG. 7 is a schematic flowchart of another method for managing a network slice according to an embodiment of this application;

FIG. 8 is a schematic flowchart of another method for managing a network slice according to an embodiment of this application;

FIG. 9 is a schematic flowchart of another method for managing a network slice according to an embodiment of this application;

FIG. 10 is a schematic block diagram of an apparatus for managing a network slice according to an embodiment of this application;

FIG. 11 is a schematic block diagram of another apparatus for managing a network slice according to an embodiment of this application;

FIG. 12 is a schematic block diagram of another apparatus for managing a network slice according to an embodiment of this application;

FIG. 13 is a schematic block diagram of another apparatus for managing a network slice according to an embodiment of this application;

FIG. 14 is a schematic block diagram of another apparatus for managing a network slice according to an embodiment of this application; and

FIG. 15 is a schematic block diagram of another apparatus for managing a network slice according to an embodiment of this application.

### DESCRIPTION OF EMBODIMENTS

The following describes the technical solutions in the embodiments of this application with reference to the accompanying drawings in the embodiments of this application.

It should be understood that the technical solutions in the embodiments of this application may be applied to various communications systems, such as a Global System for Mobile Communications (GSM) system, a Code Division Multiple Access (CDMA) system, a Wideband Code Division Multiple Access (WCDMA) system, a general packet radio service (GPRS) system, a Long Term Evolution (LTE) system, an LTE frequency division duplex (FDD) system, an LTE time division duplex (TDD) system, a Universal Mobile Telecommunications System (UMTS), a Worldwide Interoperability for Microwave Access (WiMAX) communications system, and a future 5G communications system.

The embodiments of this application relate to a network slicing technology. The network slicing technology is to logically abstract a network into one or more network slices isolated from each other, where each network slice includes a series of logical network functions, to meet diversified requirements of different service types in a targeted manner. For example, in a 5th Generation (5G) network, network slicing is an on-demand networking mode, providing an operator with a new service that can be adjusted based on a changing user requirement and that can quickly meet a novel application requirement.

The network slicing technology abstracts a 5G network physical infrastructure resource into a plurality of mutually independent parallel network slices based on a scenario requirement. Customized tailoring of a network function and orchestration and management of the corresponding network function are performed on each network slice based on a requirement of a service scenario and a service model. One network slice may be considered as an instantiated 5G network. Such a network structure allows an operator to provide a network as a service to a user, and can freely combine physical networks based on indicators such as rate, capacity, coverage, latency, reliability, security, and availability, to satisfy different user requirements.

In the network slicing technology, network slice lifecycle management is a key issue that needs to be considered. The network slice lifecycle management includes creation, combination, updating, deletion, and the like of network slices. For creation, combination, and updating of network slices, a network device should determine an available network resource for each network slice, and configure a particular network function and parameter for the network slice. For deletion of a network slice, the network device should release those particular network functions and network resources.

It should be understood that the foregoing network device may be a network management device in a network management system. Specifically, the network device may be a device that includes a network slice lifecycle management NS-LCM module, a device that includes a network slice orchestration NSO module, or a device that includes a network slice control NSC module, or the like described below. This is not limited in an embodiment of this application.

In the network slice lifecycle management, how to implement updating of a network slice is a problem that urgently needs to be resolved. Updating of a network slice includes expanding and diminishing of the network slice. Specifically, when a network slice needs to be expanded based on a service requirement (for example, due to a requirement of service expansion, a machine type communication network slice is expanded from serving 800 terminals previously, to serving 2000 terminals), or when a network needs to diminish a network slice (for example, an original bandwidth requirement of an ultra bandwidth type communication network slice is 1000 M, but now due to a limitation of network resources, only a 500 M bandwidth can be provided for the network slice), the related network slice needs to be diminished.

In this specification, updating of a network slice should be construed as updating of a network resource for the network slice, including two cases: diminishing or expanding the network slice. A network function of the network slice and a service type of a service provided by the network slice do not change.

FIG. 1 shows a network management architecture 100 to which an embodiment of this application is applied. The network management architecture 100 may include at least one network element (NE), at least one network element management (EM) module, at least one domain manager (DM), a network slice control (NSC) module, a network slice orchestration (NSO) module, a network slice lifecycle management (NS-LCM) module, and a network management (NM) module.

The NE module is a minimum unit that can be monitored and managed in the network management architecture 100. The EM module may be responsible for managing a single NE, and provides a function of processing a single NE. For example, the function includes alarm management, notification management, logging, and hardware and software maintenance.

Optionally, it should be understood that, at least some network functions of a network slice may be performed physically by the NE. To be specific, a network slice indicates a series of logical network functions, and an entity that performs a network slicing function may be the NE.

The NM module is responsible for managing an entire network, and may be supported by a plurality of EM modules, or may be directly connected to the NE. The NM may mainly provide a network management function, a function of managing interaction between devices, and other related functions, for example, network resource distribution, configuration, control, and monitoring. For example, the NM may be a module having a function of a network manager in a conventional 3GPP telecommunications network management architecture.

The NS-LCM module is mainly responsible for network slice lifecycle management, for example, including design, creation, deletion, modification, and the like of a network slice. Specifically, at least one of the following functions may be included: (1) receiving an application/service requirement, for example, a quantity of devices that need to be supported/served, a latency and a throughput of a data stream, a coverage range, or an economic parameter (such as a charging manner); (2) converting an application/service requirement into a network requirement, where for example, if a user requirement is a device quantity and a coverage range, a corresponding network requirement is a throughput/latency of a network connection, a quantity of base stations, or the like; and (3) generating a network slice descriptor (NSD), and describing a composition of a network slice, for example, a network slice identifier (NS-ID), a network function, or a network slice topology (a connection mode, an interface, or a key performance indicator (KPI) requirement. Specifically, the network function may be a function of a large granularity, for example, a mobility management function, a connection management function, or an access control function, or may be an atomic function, for example, a robust header compression (ROHC) function, an encryption/decryption function, or a reordering function of a Packet Data Convergence Protocol (PDCP) layer; an automatic repeat request (ARQ) function, a packet fragmentation function, or a reordering function of a Radio Link Control (RLC) layer; or a hybrid automatic repeat request (HARQ) function or a multiplexing/demultiplexing function of a Medium Access Control (MAC) layer. The network slice topology may be used to indicate a connection mode, an interface, a KPI requirement (which may include a bandwidth, a latency, or a throughput) and the like between network functions of the network slice.

The NSO module may orchestrate a network resource based on a network slice requirement generated by the NS-LCM module and an actually owned network resource. The network resource may include a link resource, a storage resource, a computing resource, or other network resources described above.

The NSC module may be mainly configured to configure and manage a network resource, to meet a requirement of the network slice.

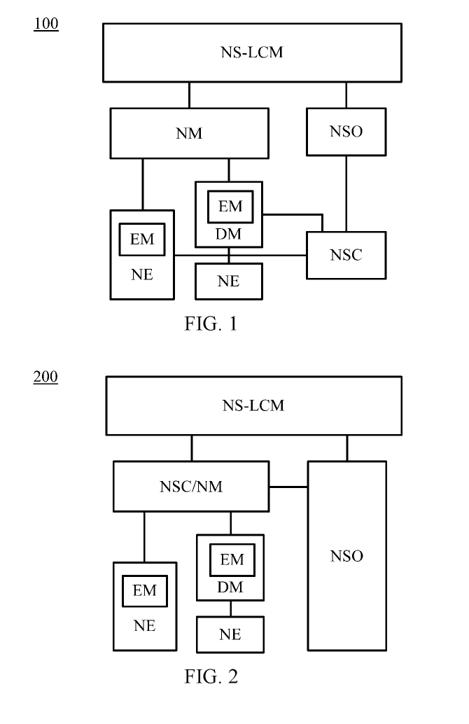

FIG. 2 shows another network management architecture 200 to which an embodiment of this application is applied. In FIG. 2, an NSC module and an NM module may be combined into one function module. The function module has all functions of the NSC module and the NM module. The combined function module may be an NSC/NM in FIG. 2. The NSC/NM is connected to an NS-LCM module, an NSO module, and each EM module by using an interface. A function of the interface between the NSC/NM and other modules is equivalent to a combination of functions of interfaces separately between the NSC module and other modules and between the NM module and other modules. For the function of the interface, refer to specific descriptions in FIG. 1. Details are not described herein again.

In addition, it should be noted that the function modules and units introduced above are considered from a perspective of the functions of the function modules and units. During actual application, each of the foregoing function modules may be a separate physical entity, or two or more devices may be integrated into one unit. For example, the NS-LCM module and the NSO module may be combined into one function module, and the function module has all functions of the NS-LCM module and the NSO module, or the NM and the NSC may be combined into one function module. A person of ordinary skill in the art can readily conceive of various equivalent modifications or replacements within the technical scope disclosed in this application, and such modifications or replacements should fall within the protection scope of this application.

It should be understood that, a first network device mentioned in this specification may be a device that includes the NSO module (briefly referred to as “NSO” below), a second network device may be a device that includes the NS-LCM module (briefly referred to as “NS-LCM” below), a third network device may be a device that includes the NSC module (briefly referred to as “NSC” below), and a fourth network device may be a device that includes the NM module (briefly referred to as “NM” below). During management and orchestration of a network slice, the first network device, the second network device, the third network device, and the fourth network device may be used to implement respective corresponding functions, thereby flexibly managing the network slice.

It should be understood that, the first network device, the second network device, the third network device, and the fourth network device may be specifically network management devices, configured to monitor, manage, and maintain a network element during network operation and maintenance. However, the embodiments of this application are not limited thereto.

For ease of understanding, the embodiments of this application are described below by using an NSO, an NS-LCM, an NSC, and an NM as execution bodies. However, this is not limited in the embodiments of this application.

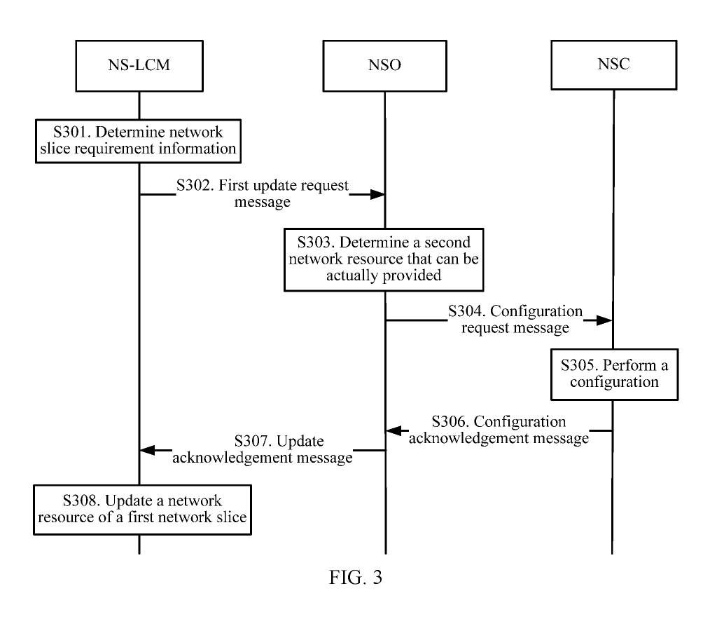

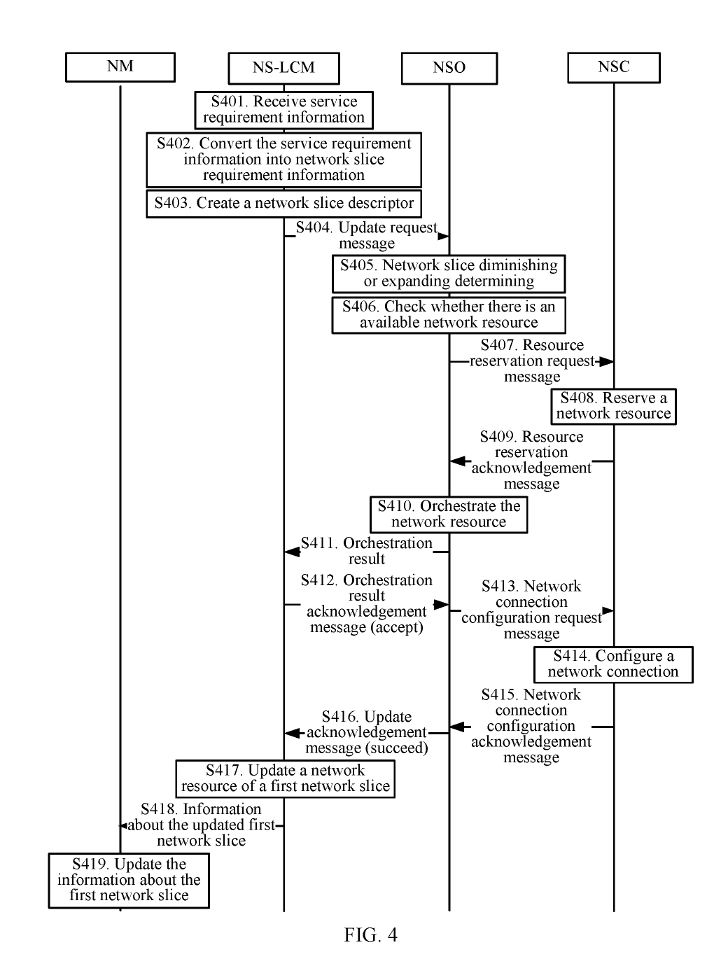

FIG. 3 shows a method 300 for managing a network slice according to an embodiment of this application. The method 300 may be applied to the network management architecture 100 shown in FIG. 1, or may be applied to the network management architecture 200 shown in FIG. 2. This is not limited in an embodiment of this application.

S301. An NS-LCM determines network slice requirement information, where the network slice requirement information is used to indicate that a network resource of a first network slice needs to be updated to a first network resource. The network resource herein may be a link resource, a storage resource, a computing resource, or the like used by the first network slice.

S302. The NS-LCM sends a first update request message to an NSO, where the first update request message carries the network slice requirement information, and the network slice requirement information carries information about the first network resource. The NSO receives the first update request message.

S303. The NSO determines, based on the information that is about the first network resource and that is carried in the first update request message, a second network resource that can be actually provided for the first network slice. Herein, the second network resource may be the same as or different from the first network resource.

S304. The NSO sends a configuration request message to an NSC, where the configuration request message carries information about the second network resource. The NSC receives the configuration request message.

S305. The NSC configures the second network resource based on the configuration request message. Specifically, the NSC may configure an association relationship between a network function of the first network slice and the second network resource.

S306. The NSC sends a configuration acknowledgement message to the NSO, and the NSO receives the configuration acknowledgement message.

S307. The NSO sends an update acknowledgement message to the NS-LCM, and the NS-LCM receives the update acknowledgement message.

S308. The NS-LCM updates the network resource of the first network slice, to be specific, updates the network resource of the first slice to the second network resource.

It should be understood that in the foregoing procedure, the first network resource is a network resource for the first network slice, and the second network resource is a network resource that can be provided for the first network slice based on an actual network status. In at least one embodiment of the application, the first network resource may be the same as or different from the second network resource. If the first network resource is different from the second network resource, the second network resource is included in the first network resource. For example, if the network slice requirement information indicates that the first network slice needs to update a network bandwidth to an 800 M bandwidth, the 800 M bandwidth is the first network resource. If the NSO can actually provide an 800 M bandwidth for the first network slice based on an actual network status, the second network resource is the 800 M bandwidth, and the second network resource is the same as the first network resource. If the NSO determines that the network can actually provide only a 600 M bandwidth for the first network slice, the second network resource is the 600 M bandwidth.

Therefore, for a case of requesting to diminish the network slice, network resources are sufficient, and the first network resource is the same as the second network resource. For a case of requesting to expanding the network slice, it needs to be determined whether there is an available network resource, and a network resource is allocated to the first network slice based on an actual case. In this case, the first network resource may be the same as or different from the second network resource.

In addition, the network slice requirement information may carry only some information that changes compared with an original network resource of the first network slice, or may carry all network resources needed for the first network slice. This is not limited in an embodiment of this application.

Specifically, in S301, the network slice requirement information may include an identifier of the first network slice and the first network resource needed for the first network slice, or may further include a new network slice descriptor generated by the first network slice. This is not limited in an embodiment of this application. In addition, the NS-LCM may determine the network slice requirement information in a plurality of manners. This is also not limited in an embodiment of this application.

In an optional embodiment, S301 of determining, by an NS-LCM, network slice requirement information includes: receiving, by the NS-LCM, a second update request message, where the second update request message carries service requirement information of a user; and determining, by the NS-LCM, the network slice requirement information based on the service requirement information.

In an optional embodiment, S301 of determining, by an NS-LCM, network slice requirement information includes: receiving, by the NS-LCM, a third update request message sent by the NSC, where the third update request message carries the network slice requirement information; and determining, by the NS-LCM, the network slice requirement information based on the third update request message.

Specifically, in S303, the NSO may determine, in a plurality of manners, the second network resource that can be actually provided for the first network slice. This is not limited in an embodiment of this application.

In an optional embodiment, S303 of determining, by the NSO based on the first update request message, a second network resource that can be actually provided for the first network slice includes: determining, by the NSO, the first network resource as the second network resource when the first network resource is included in a third network resource currently occupied by the first network slice.

In an optional embodiment, S303 of determining, by the NSO based on the first update request message, a second network resource that can be actually provided for the first network slice includes: sending, by the NSO, a reservation request message to the NSC when a third network resource currently occupied by the first network slice is included in the first network resource and it is determined that there is no available network resource, where the reservation request message carries information about the first network resource; receiving, by the NSO, a reservation acknowledgement message sent by the NSC based on the reservation request message, where the reservation acknowledgement message carries information about the second network resource; and determining, by the NSO, the second network resource based on the reservation acknowledgement message.

Herein, the third network resource is an original network resource of the first network slice, and the NSO may compare the requested first network resource with the original third network resource, to determine whether to request to diminish or expand the first network slice. For a case of requesting to diminish the first network slice, the first network resource is directly determined as the second network resource. For a case of requesting to expand the first network slice, the NSO may send the reservation request message to the NSC, and after reserving a resource, the NSC allocates, to the first network slice based on an actual case, the second network resource that can be actually provided.

In an optional embodiment, S303 of determining, by the NSO based on the first update request message, a second network resource that can be actually provided for the first network slice includes: determining, by the NSO, the second network resource based on a plurality of update request messages, where the plurality of update request messages are used to request to update network resources of a plurality of network slices, the plurality of update request messages include the first update request message, and the plurality of network slices include the first network slice.

In at least one embodiment, the NSO may receive the plurality of update request messages at a same time, for updating the network resources of the plurality of network slices. In this case, the NSO needs to orchestrate available network resources, to meet requirements of the plurality of network slices as much as possible. The orchestration herein specifically refers to determining, for each network slice, a network resource that can be actually provided. For example, the NSO receives three update request messages for requesting to provide a 100 M bandwidth for the first network slice, to provide a 200 M bandwidth for a second network slice, and to provide a 150 M bandwidth for a third network slice, and the NSO determines that an available network resource is 300 M. In this case, the NSO may meet requirements of the first network slice and the second network slice (that is, orchestrate a 100 M bandwidth for the first network slice and a 200 M bandwidth for the second network slice), or meet requirements of the first network slice and the third network slice (that is, orchestrate a 100 M bandwidth for the first network slice and a 150 M bandwidth for the third network slice), or any other combination may be used. This is not limited in an embodiment of this application.

In an optional embodiment, before S304 of sending, by the NSO, a configuration request message to an NSC, the method further includes: sending, by the NSO, a resource acknowledgement message to the NS-LCM, where the resource acknowledgement message carries the information about the second network resource; receiving, by the NS-LCM, the resource acknowledgement message sent by the NSO, and sending, by the NS-LCM, a resource accept message to the NSO if the NS-LCM determines to accept updating of the network resource of the first network slice to the second network resource, where the resource accept message is used to indicate that updating of the network resource of the first network slice to the second network resource is accepted; and receiving, by the NSO, the resource accept message sent by the NS-LCM based on the resource acknowledgement message, where the resource accept message is used to indicate that updating of the network resource of the first network slice to the second network resource is accepted.

Specifically, after the NSO determines the second network resource provided for the first network slice, if the second network resource is different from the first network resource requested by the NS-LCM, the NSO may first send the resource acknowledgement message to the NS-LCM, to determine whether the NS-LCM accepts the second network resource, and then configure the second network resource if the NS-LCM accepts the second network resource. This can avoid a case in which the NS-LCM does not accept the network resource allocated by the NSO to the NS-LCM after the network resource is configured.

It should be understood that the resource acknowledgement message may carry only a network resource different from that in the network slice requirement information, or may carry all network resources reallocated to the first network slice. This is not limited in an embodiment of this application.

In an optional embodiment, after S308 of updating, by the NS-LCM, the network resource of the first network slice based on the update acknowledgement message, the method further includes: sending, by the NS-LCM, information about the first network slice to an NM, where the information includes the information about the second network resource.

The NM herein may be construed as a device with a network management function. The NM may perform corresponding backup based on the received information about the updated first network slice, thereby facilitating network management.

In an optional embodiment, after the sending, by the NSC, a reservation acknowledgement message to the NSO, the method further includes: updating, by the NSC, information about the first network slice, where the information includes the information about the second network resource.

When the NSC has the function of the foregoing NM, the NSC may directly update the stored information about the first network slice, thereby implementing network management.

It should be understood that the NSC and the NM may be a same device or may be different devices. This is not limited in an embodiment of this application.

In at least one embodiment of this application, the NSO receives the update request message sent by the NS-LCM, and determines, based on the network slice requirement information carried in the update request message and based on the actual network status, the network resource that can be actually provided for the requested first network slice. After the NSO orchestrates the network resource that can be actually provided, and after configuring, by using the NSC, the network resource that can be actually provided, the NSO sends the update acknowledgement message to the NS-LCM. The NS-LCM updates the network resource of the first network slice based on the update acknowledgement message. To be specific, the NS-LCM updates the network resource of the first network slice to the foregoing network resource that can be actually provided. In this way, a network slice can be updated based on the actual network status, thereby properly using the network resource.

It should be understood that, sequence numbers of the foregoing processes do not indicate an execution sequence, and an execution sequence of processes shall be determined based on functions and internal logic thereof, and shall constitute no limitation on an implementation process of the embodiments of this application.

FIG. 4 shows another method 400 for managing a network slice according to an embodiment of this application. The method 400 may be applied to the network management architecture 100 shown in FIG. 1, but an embodiment of this application is not limited thereto.

In S401, an NS-LCM receives service requirement information sent by a user or an operator, where the service requirement information may be a quantity of devices that need to be served by the service, a coverage range, or the like.

Specifically, for example, the NS-LCM may include a user-oriented upper layer application interface. The NS-LCM may receive service request information of a computer application program of the user by using the upper layer application interface. The service request message may be a service termination request. For example, the upper layer application interface may be an application programming interface (Application Programming Interface, API), and the foregoing user may be a terminal device.

In S402, the NS-LCM determines, based on the service requirement information, a first network slice corresponding to the service, and converts the service requirement information into network slice requirement information, where the network slice requirement information is used to indicate a first network resource needed for the first network slice, for example, a quantity of base stations, or a quantity of base stations that need to be increased or reduced.

In S403, the NS-LCM creates a new network slice descriptor NSD based on the network slice requirement information, to update a component element of the first network slice, where the new network slice descriptor includes an identifier of the first network slice and information about the first network resource.

In S404, the NS-LCM sends an update request message to an NSO, where the update request message carries the foregoing new network slice descriptor. The NSO receives the update request message.

In S405, the NSO compares the new network slice descriptor carried in the update request message with an original network slice descriptor of the first network slice, to determine whether to diminish or expand the first network slice.

Specifically, for example, due to a requirement of service expansion, the first network slice is requested to be expanded from serving 800 terminals previously, to serving 2000 terminals. Therefore, the first network slice needs to be expanded. Alternatively, an original bandwidth requirement of the first network slice is 1000 M, but now due to a limitation of network resources, only a 500 M bandwidth can be provided for the first network slice. In this case, the first network slice needs to be diminished. Because there are many types of network resources, an embodiment of this application is not limited thereto.

If the NSO determines that the first network slice needs to be expanded, S406 is performed. If the NSO determines that the first network slice needs to be diminished, S410 and S413 to S419 are directly performed.

In S406, the NSO checks whether there is an available network resource, and if there is no available network resource, S407 to S419 are performed; or if there is an available network resource, S410 and S413 to S419 are directly performed.

In S407, the NSO sends a resource reservation request message to an NSC, where the resource reservation request message carries the information about the first network resource requested by the NS-LCM. The network resource may include a link resource, a storage resource, a computing resource, or the like. The NSC receives the resource reservation request message.

In S408, the NSC reserves a second network resource for the first network slice based on an actual network status.

In S409, the NSC sends a resource reservation acknowledgement message to the NSO, where the resource reservation acknowledgement message carries the second network resource that can be actually provided for the first network slice. The NSO receives the resource reservation acknowledgement message.

In S410, the NSO determines, based on the resource reservation acknowledgement message, the second network resource that can be actually provided for the first network slice, and orchestrates the second network resource.

In S411, the NSO sends, to the NS-LCM, an orchestration result for the second network resource, where the orchestration result may include a parameter that is inconsistent with the new network slice descriptor. The NS-LCM receives the orchestration result.

It should be understood that, when the second network resource that can be actually provided for the first network slice is inconsistent with the first network resource requested in the service requirement information, the NSO provides, for the first network slice, the second network resource that can be actually provided. In this case, the NS-LCM needs to determine whether to accept the orchestration result.

In S412, the NS-LCM determines to receive the orchestration result, and sends an orchestration result acknowledgement message to the NSO, where the orchestration result acknowledgement message is used to acknowledge acceptance of the orchestration result. The NSO receives the orchestration result acknowledgement message.

Optionally, the orchestration result acknowledgement message may be 0 or 1, and it is agreed upon by the NSO and the NS-LCM in advance that 0 indicates that the orchestration result is not accepted and 1 indicates that the orchestration result is accepted. The orchestration result acknowledgement message may alternatively be 00 or 11, or other information. This is not limited in an embodiment of this application.

In S413, if the NSO determines, based on the orchestration result acknowledgement message, that the NS-LCM accepts the orchestration result, the NSO sends a network connection configuration request message to the NSC, to request to configure a network connection of the first network slice. The NSC receives the network connection configuration request message.

In S414, the NSC configures the network connection of the first network slice.

In S415, the NSC sends a network connection configuration acknowledgement message to the NSO, to notify the NSO that the network connection has been configured. The NSO receives the network connection configuration acknowledgement message.

In S416, the NSO sends an update acknowledgement message to the NS-LCM, where the update acknowledgement message is used to acknowledge successful configurations of a network resource and the network connection of the first network slice. The NS-LCM receives the update acknowledgement message.

Optionally, the update acknowledgement message may be 0 or 1, and it is agreed upon by the NSO and the NS-LCM in advance that 0 indicates that the updating of the network resource fails and 1 indicates that the network resource is successfully updated. The update acknowledgement message may alternatively be 00 or 11, or other information. This is not limited in an embodiment of this application.

In S417, the NS-LCM updates the network resource of the first network slice.

In S418, after updating the network resource of the first network slice, the NS-LCM sends information about the updated first network slice to an NM. The NM receives the information about the updated first network slice.

In S419, the NM centrally performs backup and management based on the information about the first network slice.

In the method for managing a network slice in an embodiment of this application, the NSO determines the second network resource that can be actually provided for the first network slice and orchestrates the second network resource. If the second network resource is inconsistent with the first network resource requested by the NS-LCM, the NSO first sends the orchestration result to the NS-LCM, and determines whether the NS-LCM accepts the orchestration result. If the NS-LCM accepts the orchestration result, the NSO configures, by using the NSC, the corresponding network resource. In this way, a network slice can be updated based on the actual network status, thereby properly using the network resource.

It should be understood that, sequence numbers of the foregoing processes do not indicate an execution sequence, and an execution sequence of processes shall be determined based on functions and internal logic thereof, and shall constitute no limitation on an implementation process of the embodiments of this application.

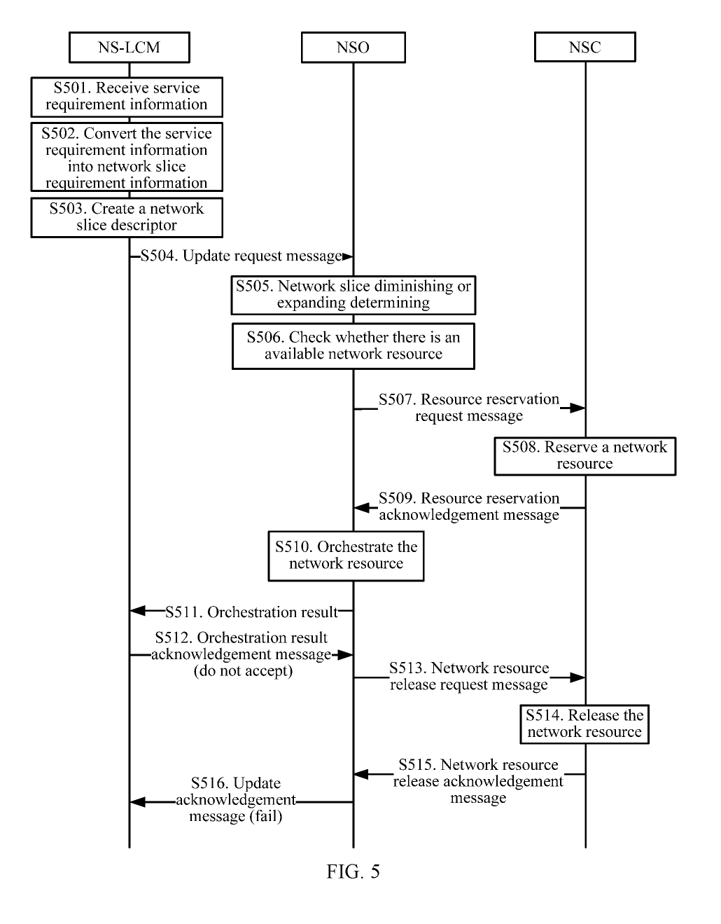

FIG. 5 shows another method 500 for managing a network slice according to an embodiment of this application. The method 500 may be applied to the network management architecture 100 shown in FIG. 1, or may be applied to the network management architecture 200 shown in FIG. 2, but an embodiment of this application is not limited thereto.

An embodiment of this application describes a case in which the second network resource that can be actually provided for the first network slice is inconsistent with the first network resource requested in the service requirement information. In an embodiment of this application, S501 to S511 are the same as S401 to S411 in FIG. 4, and details are not described herein again.

In S512, after receiving the orchestration result sent by the NSO, the NS-LCM does not accept the orchestration result, and sends an orchestration result acknowledgement message to the NSO, where the orchestration result acknowledgement message indicates that the NSO does not accept the orchestration result. The NSO receives the orchestration result acknowledgement message.

In S513, after determining that the NS-LCM does not accept the orchestration result, the NSO sends a network resource release request message to the NSC, to request the NSC to release a reserved network resource. The NSC receives the network resource release request message.

In S514, the NSC releases a previously reserved network resource based on the network resource release request message.

In S515, the NSC sends a network resource release acknowledgement message to the NSO. The NSO receives the network resource release acknowledgement message.

In S516, the NSO acknowledges that the network resource has been released, and sends an update acknowledgement message to the NS-LCM, where the update acknowledgement message is used to indicate that updating of the network resource of the first network slice fails.

In the method for managing a network slice in an embodiment of this application, the NSO determines the second network resource that can be actually provided for the first network slice and orchestrates the second network resource. If the second network resource is inconsistent with the first network resource requested by the NS-LCM, the NSO first sends the orchestration result to the NS-LCM, and determines whether the NS-LCM accepts the orchestration result. If the NS-LCM does not accept the orchestration result, the NSC directly performs a configuration to release the reserved network resource, to notify the NS-LCM that the network resource update fails. This can avoid a case in which the NS-LCM does not accept an orchestration result after a new network resource has been configured, thereby avoiding waste of resources and signaling.

It should be understood that an embodiment of this application is also applicable to two application scenarios in which the NSC and the NM are two independent devices and in which the NSC and the NM are a same device.

It should be understood that sequence numbers of the foregoing processes do not mean a sequence of performing the processes. The sequence of performing the processes should be determined according to functions and internal logic of the processes, and should not be construed as any limitation on the implementation processes of the embodiments of this application.

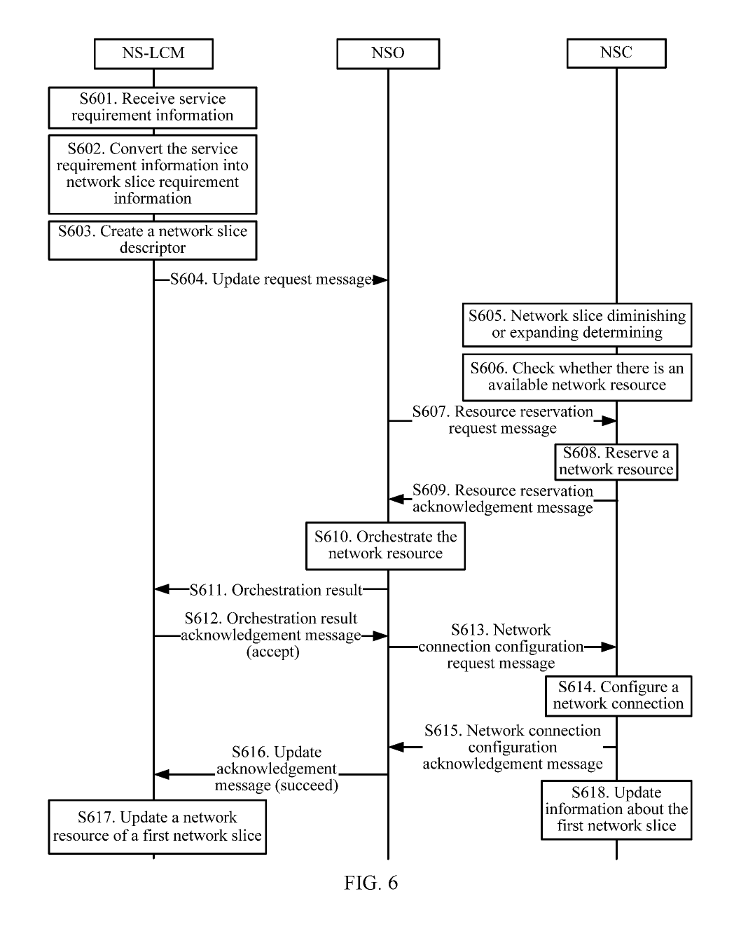

FIG. 6 shows another method 600 for managing a network slice according to an embodiment of this application. The method 600 may be applied to the network management architecture 200 shown in FIG. 2, but an embodiment of this application is not limited thereto.

In an embodiment of this application, an NSC has a related function of an NM. S601 to S617 are the same as S401 to S417 in FIG. 4, and details are not described herein again.

S618. The NSC updates information about the first network slice and is configured to back up and manage the information about the first network slice.

It should be understood that S618 does not need to be performed after S617 ends, and S618 can be triggered as long as being after S615.

It should be understood that sequence numbers of the foregoing processes do not mean a sequence of performing the processes. The sequence of performing the processes should be determined according to functions and internal logic of the processes, and should not be construed as any limitation on the implementation processes of the embodiments of this application.

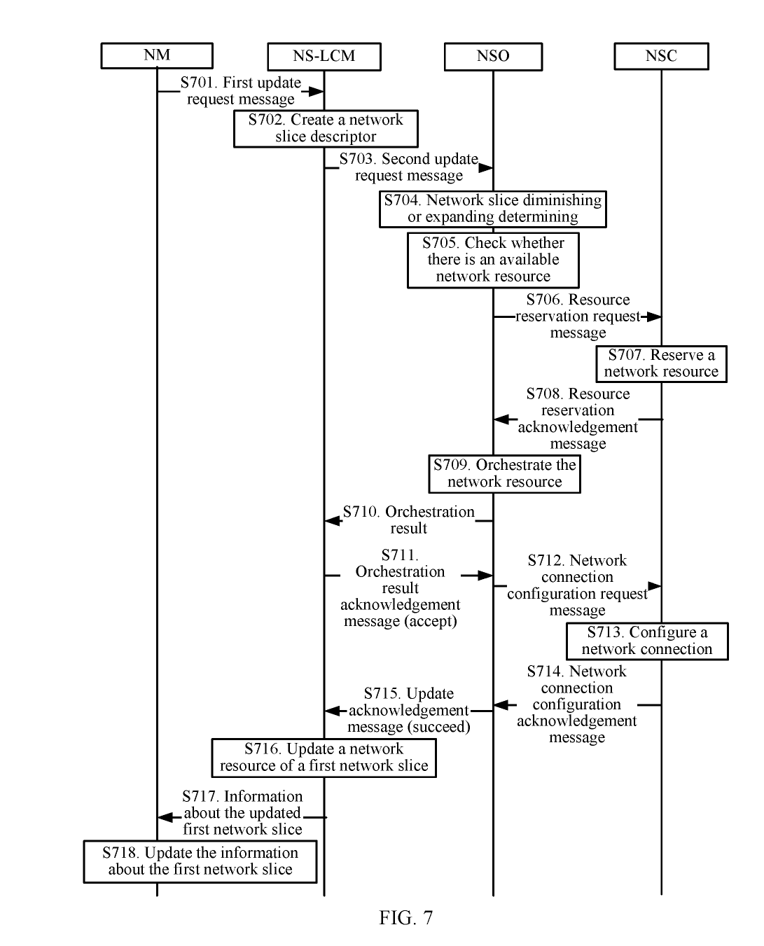

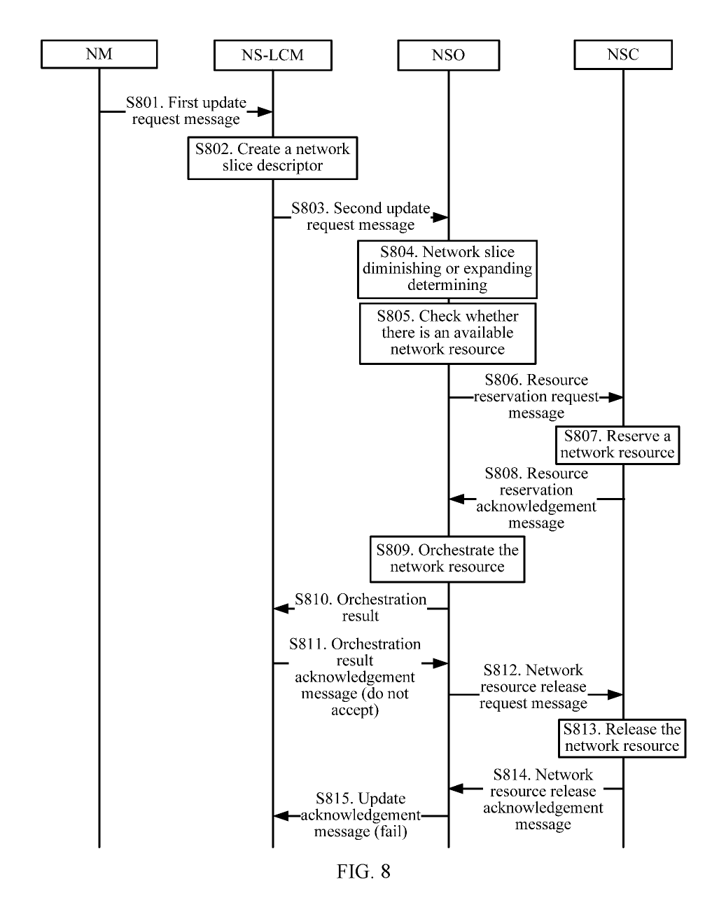

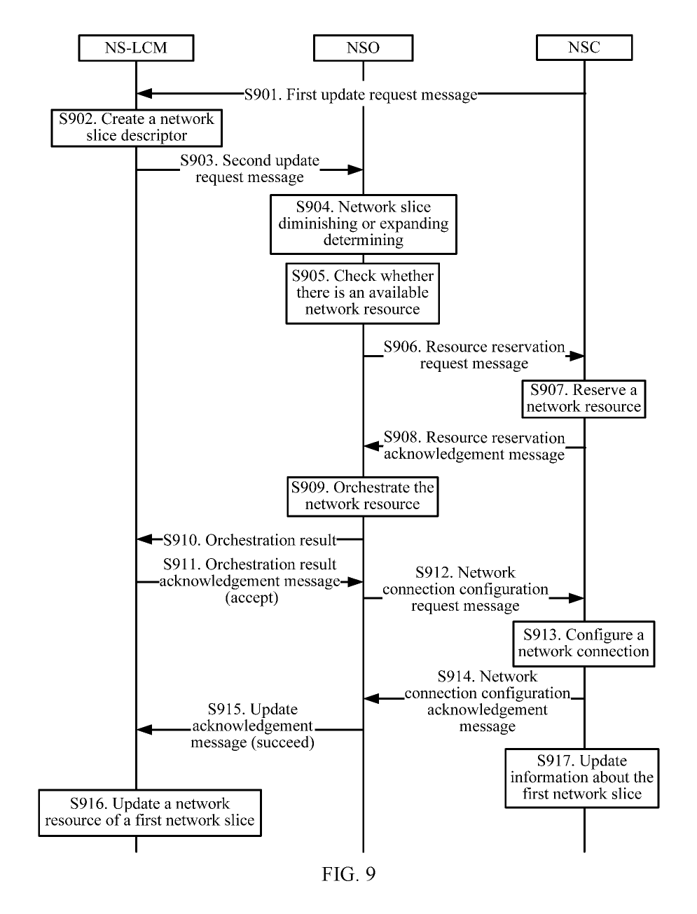

A network slice update is initiated by the NS-LCM in each of FIG. 4, FIG. 5, and FIG. 6. In addition, the network slice update may further be initiated by the NM, as shown in FIG. 7 and FIG. 8. When the NSC has the function of the NM, the network slice update may further be initiated by the NSC, as shown in FIG. 9. Detailed descriptions are provided below with reference to FIG. 7, FIG. 8, and FIG. 9 respectively.

FIG. 7 shows another method 700 for managing a network slice according to an embodiment of this application. The method 700 may be applied to the network management architecture 100 shown in FIG. 1, but an embodiment of this application is not limited thereto.

In S701, an NS-LCM receives a first update request message sent by an NM, where the first update request message carries an identifier of a first network slice and information about a first network resource that needs to be provided for the first network slice.

In S702, the NS-LCM creates a new network slice descriptor based on the first update request message, to update a component element of the first network slice, where the new network slice descriptor includes the identifier of the first network slice and the information about the first network resource.

In S703, the NS-LCM sends a second update request message to an NSO, where the second update request message carries the new network slice descriptor. The NSO receives the second update request message.

S704 to S718 are the same as S405 to S419 in FIG. 4, and details are not described herein again.

It should be understood that, sequence numbers of the foregoing processes do not indicate an execution sequence, and an execution sequence of processes shall be determined based on functions and internal logic thereof, and shall constitute no limitation on an implementation process of the embodiments of this application.

FIG. 8 shows another method 800 for managing a network slice according to an embodiment of this application. The method 800 may be applied to the network management architecture 100 shown in FIG. 1, but an embodiment of this application is not limited thereto.

An embodiment of this application describes a case in which the second network resource that can be actually provided for the first network slice is inconsistent with the first network resource requested in the service requirement information. In an embodiment of this application, S801 to S803 are the same as S701 to S703 in FIG. 7, and S804 to S815 are the same as S505 to S516 in FIG. 5. Therefore, details are not described herein again.

It should be understood that, sequence numbers of the foregoing processes do not indicate an execution sequence, and an execution sequence of processes shall be determined based on functions and internal logic thereof, and shall constitute no limitation on an implementation process of the embodiments of this application.

FIG. 9 shows another method 900 for managing a network slice according to an embodiment of this application. The method 900 may be applied to the network management architecture 200 shown in FIG. 2, but an embodiment of this application is not limited thereto.

In S901, an NSC sends a first update request message to an NS-LCM, where the first update request message carries an identifier of a first network slice and information about a first network resource that needs to be provided for the first network slice. The NS-LCM receives the first update request message.

S902 to S916 are the same as S702 to S716, and details are not described herein again.

S917. The NSC updates information about the first network slice and is configured to back up and manage the information about the first network slice.

It should be understood that FIG. 9 shows only an embodiment in which the NS-LCM accepts an orchestration result of an actually provided second network resource when the NSC initiates updating of a network slice and a requested first network resource is inconsistent with the actually provided second network resource. An embodiment in which the NS-LCM does not accept an orchestration result of an actually provided second network resource when the NSC initiates updating of a network slice and a requested first network resource is inconsistent with the actually provided second network resource, that is, an embodiment of unsuccessful updating, is similar to FIG. 5 and FIG. 8. Details are not described herein again.

It should be understood that sequence numbers of the foregoing processes do not mean a sequence of performing the processes. The sequence of performing the processes should be determined according to functions and internal logic of the processes, and should not be construed as any limitation on the implementation processes of the embodiments of this application.

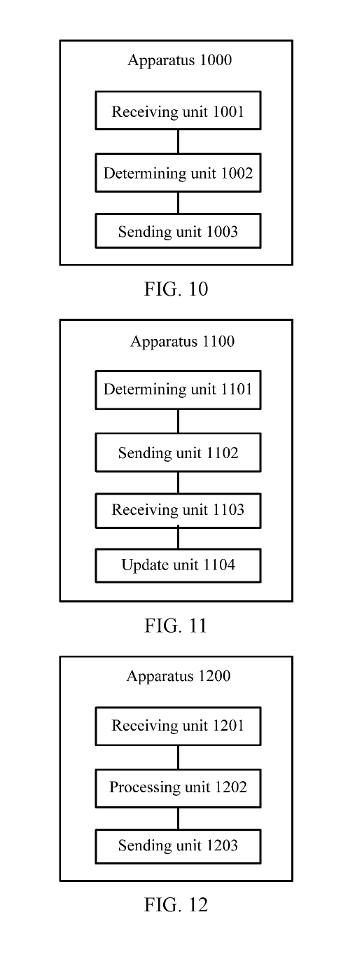

The methods for managing a network slice according to the embodiments of this application are described in detail with reference to FIG. 1 to FIG. 9 above. Apparatuses for managing a network slice according to the embodiments of this application are described in detail with reference to FIG. 10 to FIG. 15 below.

FIG. 10 shows an apparatus 1000 for managing a network slice according to an embodiment of this application. The apparatus 1000 includes:

a receiving unit 1001, configured to receive a first update request message sent by a second network device, where the first update request message carries network slice requirement information, and the network slice requirement information is used to indicate that a network resource of a first network slice needs to be updated to a first network resource; a determining unit 1002, configured to determine, based on the first update request message received by the transceiver, a second network resource that can be actually provided for the first network slice; and a sending unit 1003, configured to send an update acknowledgement message to the second network device, where the update acknowledgement message is used to instruct to update the network resource of the first network slice based on the second network resource.

Optionally, the determining unit 1002 is specifically configured to determine the first network resource as the second network resource when the first network resource is included in a third network resource currently occupied by the first network slice.

Optionally, the sending unit 1003 is specifically configured to send a reservation request message to a third network device when a third network resource currently occupied by the first network slice is included in the first network resource and it is determined that there is no available network resource, where the reservation request message carries information about the first network resource. The receiving unit 1001 is further configured to receive a reservation acknowledgement message sent by the third network device based on the reservation request message, where the reservation acknowledgement message carries information about the second network resource. The determining unit 1002 is specifically configured to determine the second network resource based on the reservation acknowledgement message.

Optionally, the determining unit 1002 is specifically configured to determine the second network resource based on a plurality of update request messages, where the plurality of update request messages are used to request to update network resources of a plurality of network slices, the plurality of update request messages include the first update request message, and the plurality of network slices include the first network slice.

Optionally, the sending unit 1003 is further configured to: before sending the update acknowledgement message to the second network device, send a configuration request message to the third network device, where the configuration request message is used to request to configure the second network resource. The receiving unit 1001 is further configured to receive a configuration acknowledgement message sent by the third network device based on the configuration request message.

Optionally, the sending unit 1003 is further configured to: before sending the configuration request message to the third network device, send a resource acknowledgement message to the second network device, where the resource acknowledgement message carries the information about the second network resource. The receiving unit 1001 is further configured to receive a resource accept message sent by the second network device based on the resource acknowledgement message, where the resource accept message is used to indicate that updating of the network resource of the first network slice to the second network resource is accepted.

It should be understood that the apparatus 1000 herein is represented in a form of a functional unit. The term “unit” herein may refer to an application-specific integrated circuit (ASIC), an electronic circuit, a processor (for example, a shared processor, a proprietary processor, or a packet processor) for performing one or more software or firmware programs and a memory, a combined logic circuit, and/or another appropriate component supporting the described function. In an optional example, a person of ordinary skill in the art may understand that the apparatus 1000 may be specifically the first network device in the foregoing embodiments. The apparatus 1000 may be configured to perform procedures and/or operations corresponding to the first network device in the foregoing method embodiments. To avoid repetition, details are not described herein again.

FIG. 11 shows another apparatus 1100 for managing a network slice according to an embodiment of this application. The apparatus 1100 includes:

a determining unit 1101, configured to determine network slice requirement information, where the network slice requirement information is used to indicate that a network resource of a first network slice needs to be updated to a first network resource; a sending unit 1102, configured to send a first update request message to a first network device based on the network slice requirement information determined by the processor, where the first update request message carries the network slice requirement information; a receiving unit 1103, configured to receive an update acknowledgement message sent by the first network device based on the first update request message, where the update acknowledgement message is used to instruct to update the network resource of the first network slice based on the second network resource; and an update unit 1104, configured to update the network resource of the first network slice to the second network resource based on the update acknowledgement message.

Optionally, the receiving unit 1103 is further configured to receive a second update request message, where the second update request message carries service requirement information of a user. The determining unit 1101 is specifically configured to determine the network slice requirement information based on the service requirement information.

Optionally, the receiving unit 1103 is further configured to receive a third update request message sent by a third network device, where the third update request message carries the network slice requirement information. The determining unit 1101 is specifically configured to determine the network slice requirement information based on the third update request message.

Optionally, the receiving unit 1103 is further configured to: after the first update request message is sent to the first network device and before the network resource of the first network slice is updated to the second network resource based on the update acknowledgement message, receive a resource acknowledgement message sent by the first network device, where the resource acknowledgement message carries information about the second network resource. The sending unit 1102 is further configured to send a resource accept message to the first network device when it is determined to accept updating of the network resource of the first network slice to the second network resource, where the resource accept message is used to indicate that updating of the network resource of the first network slice to the second network resource is accepted.

Optionally, the sending unit 1102 is further configured to: after the network resource of the first network slice is updated based on the update acknowledgement message, send information about the first network slice to a fourth network device, where the information includes the information about the second network resource.

It should be understood that the apparatus 1100 herein is represented in a form of a functional unit. The term “unit” herein may refer to an application-specific integrated circuit (ASIC), an electronic circuit, a processor (for example, a shared processor, a proprietary processor, or a packet processor) for performing one or more software or firmware programs and a memory, a combined logic circuit, and/or another appropriate component supporting the described function. In an optional example, a person of ordinary skill in the art may understand that the apparatus 1100 may be specifically the second network device in the foregoing embodiments. The apparatus 1100 may be configured to perform procedures and/or operations corresponding to the second network device in the foregoing method embodiments. To avoid repetition, details are not described herein again.

FIG. 12 shows another apparatus 1200 for managing a network slice according to an embodiment of this application. The apparatus 1200 includes:

a receiving unit 1201, configured to receive a reservation request message sent by a first network device, where the reservation request message carries information about a first network resource needed for a first network slice; a processing unit 1202, configured to reserve a second network resource based on the reservation request message received by the transceiver; and a sending unit 1203, configured to send a reservation acknowledgement message to the first network device, where the reservation acknowledgement message carries information about the second network resource and is used to update a network resource of the first network slice to the second network resource.

Optionally, the receiving unit 1201 is further configured to: after the reservation acknowledgement message is sent to the first network device, receive a configuration request message sent by the first network device, where the configuration request message carries the information about the second network resource. The processing unit 1202 is further configured to configure an association relationship between a network function of the first network slice and the second network resource based on the configuration request message. The transceiver is further configured to send a configuration acknowledgement message to the first network device.

Optionally, the receiving unit 1201 is further configured to: after the reservation acknowledgement message is sent to the first network device, receive a release request message sent by the first network device, where the release request message is used to request to release the second network resource. The processing unit 1202 is further configured to release the second network resource based on the release request message. The sending unit 1203 is further configured to send a release acknowledgement message to the first network device.

Optionally, the processing unit 1202 is further configured to: after the reservation acknowledgement message is sent to the first network device, update information about the first network slice, where the information includes the information about the second network resource.

It should be understood that the apparatus 1200 herein is represented in a form of a functional unit. The term “unit” herein may refer to an application-specific integrated circuit (ASIC), an electronic circuit, a processor (for example, a shared processor, a proprietary processor, or a packet processor) for performing one or more software or firmware programs and a memory, a combined logic circuit, and/or another appropriate component supporting the described function. In an optional example, a person of ordinary skill in the art may understand that the apparatus 1200 may be specifically the third network device in the foregoing embodiments. The apparatus 1200 may be configured to perform procedures and/or operations corresponding to the third network device in the foregoing method embodiments. To avoid repetition, details are not described herein again.

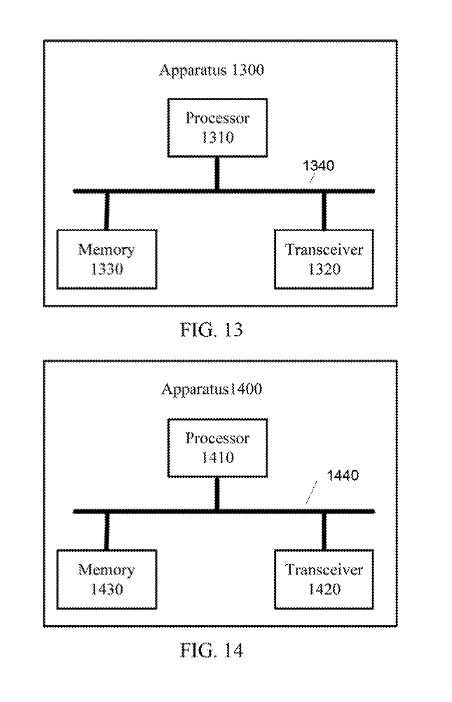

FIG. 13 shows another apparatus 1300 for managing a network slice according to an embodiment of this application. The apparatus 1300 includes a processor 1310, a transceiver 1320, a memory 1330, and a bus system 1340. The processor 1310, the transceiver 1320, and the memory 1330 are connected to each other by using the bus system 1340. The memory 1330 is configured to store an instruction. The processor 1310 is configured to execute the instruction stored in the memory 1330, to control the transceiver 1320 to send a signal and/or receive a signal.

The transceiver 1320 is configured to receive a first update request message sent by a second network device, where the first update request message carries network slice requirement information, and the network slice requirement information is used to indicate that a network resource of a first network slice needs to be updated to a first network resource. The processor 1310 is configured to determine, based on the first update request message received by the transceiver, a second network resource that can be actually provided for the first network slice. The transceiver 1320 is configured to send an update acknowledgement message to the second network device, where the update acknowledgement message is used to instruct to update the network resource of the first network slice based on the second network resource.

Optionally, the processor 1310 is specifically configured to determine the first network resource as the second network resource when the first network resource is included in a third network resource currently occupied by the first network slice.

Optionally, the transceiver 1320 is specifically configured to send a reservation request message to a third network device when a third network resource currently occupied by the first network slice is included in the first network resource and it is determined that there is no available network resource, where the reservation request message carries information about the first network resource. The transceiver 1320 is further configured to receive a reservation acknowledgement message sent by the third network device based on the reservation request message, where the reservation acknowledgement message carries information about the second network resource. The processor 1310 is specifically configured to determine the second network resource based on the reservation acknowledgement message.

Optionally, the processor 1310 is specifically configured to determine the second network resource based on a plurality of update request messages, where the plurality of update request messages are used to request to update network resources of a plurality of network slices, the plurality of update request messages include the first update request message, and the plurality of network slices include the first network slice.

Optionally, the transceiver 1320 is further configured to: before sending the update acknowledgement message to the second network device, send a configuration request message to the third network device, where the configuration request message is used to request to configure the second network resource. The transceiver 1320 is further configured to receive a configuration acknowledgement message sent by the third network device based on the configuration request message.

Optionally, the transceiver 1320 is further configured to: before sending the configuration request message to the third network device, send a resource acknowledgement message to the second network device, where the resource acknowledgement message carries the information about the second network resource. The transceiver 1320 is further configured to receive a resource accept message sent by the second network device based on the resource acknowledgement message, where the resource accept message is used to indicate that updating of the network resource of the first network slice to the second network resource is accepted.

It should be understood that the apparatus 1300 may be specifically the first network device in the foregoing embodiments, and may be configured to perform operations and/or procedures corresponding to the first network device in the foregoing method embodiments. Optionally, the memory 1330 may include a read-only memory and a random access memory, and provide an instruction and data to the processor. A part of the memory may further include a non-volatile random access memory. For example, the memory may further store device type information. The processor 1310 may be configured to execute the instruction stored in the memory, and when the processor 1310 executes the instruction stored in the memory, the processor 1310 is configured to perform operations and/or procedures in the method embodiments corresponding to the first network device.

FIG. 14 shows another apparatus 1400 for managing a network slice according to an embodiment of this application. The apparatus 1400 includes a processor 1410, a transceiver 1420, a memory 1430, and a bus system 1440. The processor 1410, the transceiver 1420, and the memory 1430 are connected to each other by using the bus system 1440. The memory 1430 is configured to store an instruction. The processor 1410 is configured to execute the instruction stored in the memory 1430, to control the transceiver 1420 to send a signal and/or receive a signal.

The processor 1410 is configured to determine network slice requirement information, where the network slice requirement information is used to indicate that a network resource of a first network slice needs to be updated to a first network resource. The transceiver 1420 is configured to send a first update request message to a first network device based on the network slice requirement information determined by the processor, where the first update request message carries the network slice requirement information. The transceiver 1420 is configured to receive an update acknowledgement message sent by the first network device based on the first update request message, where the update acknowledgement message is used to instruct to update the network resource of the first network slice based on the second network resource. The processor 1410 is further configured to update the network resource of the first network slice to the second network resource based on the update acknowledgement message.

Optionally, the transceiver 1420 is further configured to receive a second update request message, where the second update request message carries service requirement information of a user. The processor 1410 is specifically configured to determine the network slice requirement information based on the service requirement information.

Optionally, the transceiver 1420 is further configured to receive a third update request message sent by a third network device, where the third update request message carries the network slice requirement information. The processor 1410 is specifically configured to determine the network slice requirement information based on the third update request message.

Optionally, the transceiver 1420 is further configured to: after sending the first update request message to the first network device and before the network resource of the first network slice is updated to the second network resource based on the update acknowledgement message, receive a resource acknowledgement message sent by the first network device, where the resource acknowledgement message carries information about the second network resource. The transceiver 1420 is further configured to send a resource accept message to the first network device when it is determined to accept updating of the network resource of the first network slice to the second network resource, where the resource accept message is used to indicate that updating of the network resource of the first network slice to the second network resource is accepted.

Optionally, the transceiver 1420 is further configured to: after the network resource of the first network slice is updated based on the update acknowledgement message, send information about the first network slice to a fourth network device, where the information includes the information about the second network resource.

It should be understood that the apparatus 1400 may be specifically the second network device in the foregoing embodiments, and may be configured to perform operations and/or procedures corresponding to the second network device in the foregoing method embodiments. Optionally, the memory 1430 may include a read-only memory and a random access memory, and provide an instruction and data to the processor. A part of the memory may further include a non-volatile random access memory. For example, the memory may further store device type information. The processor 1410 may be configured to execute the instruction stored in the memory, and when the processor 1310 executes the instruction stored in the memory, the processor 1310 is configured to perform operations and/or procedures in the method embodiments corresponding to the second network device.

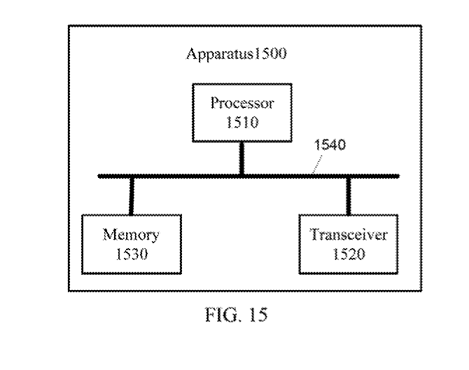

FIG. 15 shows another apparatus 1500 for managing a network slice according to an embodiment of this application. The apparatus 1500 includes a processor 1510, a transceiver 1520, a memory 1530, and a bus system 1540. The processor 1510, the transceiver 1520, and the memory 1530 are connected to each other by using the bus system 1540. The memory 1530 is configured to store an instruction. The processor 1510 is configured to execute the instruction stored in the memory 1530, to control the transceiver 1520 to send a signal and/or receive a signal.

The transceiver 1520 is configured to receive a reservation request message sent by a first network device, where the reservation request message carries information about a first network resource needed for a first network slice. The processor 1510 is configured to reserve a second network resource based on the reservation request message received by the transceiver. The transceiver 1520 is configured to send a reservation acknowledgement message to the first network device, where the reservation acknowledgement message carries information about the second network resource and is used to update a network resource of the first network slice to the second network resource.

Optionally, the transceiver 1520 is further configured to: after sending the reservation acknowledgement message to the first network device, receive a configuration request message sent by the first network device, where the configuration request message carries the information about the second network resource. The processor 1510 is further configured to configure an association relationship between a network function of the first network slice and the second network resource based on the configuration request message. The transceiver is further configured to send a configuration acknowledgement message to the first network device.

Optionally, the transceiver 1520 is further configured to: after sending the reservation acknowledgement message to the first network device, receive a release request message sent by the first network device, where the release request message is used to request to release the second network resource. The processor 1510 is further configured to release the second network resource based on the release request message. The transceiver 1520 is further configured to send a release acknowledgement message to the first network device.

Optionally, the processor 1510 is further configured to: after the reservation acknowledgement message is sent to the first network device, update information about the first network slice, where the information includes the information about the second network resource.

It should be understood that the apparatus 1500 may be specifically the third network device in the foregoing embodiments, and may be configured to perform operations and/or procedures corresponding to the third network device in the foregoing method embodiments. Optionally, the memory 1530 may include a read-only memory and a random access memory, and provide an instruction and data to the processor. A part of the memory may further include a non-volatile random access memory. For example, the memory may further store device type information. The processor 1510 may be configured to execute the instruction stored in the memory, and when the processor 1510 executes the instruction stored in the memory, the processor 1510 is configured to perform operations and/or procedures in the method embodiments corresponding to the third network device.

It should be understood that in the embodiment of this application, the processor in the foregoing apparatus may be a central processing unit (CPU), or the processor may be another general-purpose processor, a digital signal processor (DSP), an application-specific integrated circuit (ASIC), a field programmable gate array (FPGA), or another programmable logic device, discrete gate or transistor logic device, discrete hardware component, or the like. The general purpose processor may be a microprocessor or the processor may be any conventional processor, or the like.

In an implementation process, operations in the foregoing methods can be implemented by using a hardware integrated logic circuit in the processor, or by using instructions in a form of software. The operations of the method disclosed with reference to the embodiments of this application may be directly performed by a hardware processor, or may be performed by using a combination of hardware in the processor and a software unit. A software unit may be located in a mature storage medium in the art, such as a random access memory, a flash memory, a read-only memory, a programmable read-only memory, an electrically erasable programmable memory, a register, or the like. The storage medium is located in the memory, and a processor reads instructions in the memory and completes the operations in the foregoing methods in combination with hardware of the processor. To avoid repetition, details are not described herein again.

A person of ordinary skill in the art may be aware that, in combination with the examples described in the embodiments disclosed in this specification, method operations and units may be implemented by electronic hardware, computer software, or a combination thereof. To clearly describe the interchangeability between the hardware and the software, the foregoing has generally described operations and compositions of each embodiment based on functions. Whether the functions are performed by hardware or software depends on particular applications and design constraint conditions of the technical solutions. A person of ordinary skill in the art may use different methods to implement the described functions for each particular application, but it should not be considered that the implementation goes beyond the scope of this application.

It may be clearly understood by a person of ordinary skill in the art that, for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communications connections may be implemented through some interfaces, and the indirect couplings or communication connections between the apparatuses or units may be electrical connections, mechanical connections, or connections in other forms.

The units described as separate parts may or may not be physically separate, and parts displayed as units may or may not be physical units, may be located in one position, or may be distributed on a plurality of network units. Some or all of the units may be selected based on actual needs to achieve the objectives of the solutions of the embodiments of this application.

The term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

In addition, the function units in the embodiments of this application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer readable storage medium. Based on such an understanding, the technical solutions of this application essentially, or the part contributing to the prior art, or all or some of the technical solutions may be implemented in a form of a software product. The computer software product is stored in a storage medium and includes several instructions for instructing a computer device (which may be a personal computer, a server, a network device, or the like) to perform all or some of the operations of the methods described in the embodiments of this application. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any equivalent modification or replacement readily figured out by a person of ordinary skill in the art within the technical scope disclosed in this application shall fall within the protection scope of this application. Therefore, the protection scope of this application shall be subject to the protection scope of the claims.

1. A method for managing a network slice, comprising:
receiving, by a first network device, a first update request message sent by a second network device, wherein the first update request message carries network slice requirement information, and the network slice requirement information is used to indicate that a network resource of a first network slice needs to be updated to a first network resource;
determining, by the first network device based on the first update request message, a second network resource that can be actually provided for the first network slice; and
sending, by the first network device, an update acknowledgement message to the second network device, wherein the update acknowledgement message is used to update the network resource of the first network slice based on the second network resource.

2. The method according to claim 1, wherein the determining, by the first network device based on the first update request message, the second network resource that can be actually provided for the first network slice comprises:
determining, by the first network device, the first network resource as the second network resource when the first network resource is in a third network resource currently occupied by the first network slice.

3. The method according to claim 1, wherein the determining, by the first network device based on the first update request message, the second network resource that can be actually provided for the first network slice comprises:
sending, by the first network device, a reservation request message to a third network device when a third network resource currently occupied by the first network slice is in the first network resource and it is determined that there is no available network resource, wherein the reservation request message carries information about the first network resource;
receiving, by the first network device, a reservation acknowledgement message sent by the third network device based on the reservation request message, wherein the reservation acknowledgement message carries information about the second network resource; and
determining, by the first network device, the second network resource based on the reservation acknowledgement message.

4. The method according to claim 1, wherein before the sending, by the first network device, the update acknowledgement message to the second network device, the method further comprises:
sending, by the first network device, a configuration request message to the third network device, wherein the configuration request message is used to request to configure an association relationship between a network function of the first network slice and the second network resource; and
receiving, by the first network device, a configuration acknowledgement message sent by the third network device based on the configuration request message.

5. The method according to claim 4, wherein before the sending, by the first network device, the configuration request message to the third network device, the method further comprises:
sending, by the first network device, a resource acknowledgement message to the second network device, wherein the resource acknowledgement message carries the information about the second network resource; and
receiving, by the first network device, a resource accept message sent by the second network device based on the resource acknowledgement message, wherein the resource accept message is used to indicate that updating of the network resource of the first network slice to the second network resource is accepted.

6. A method for managing a network slice, comprising:
determining, by a second network device, network slice requirement information, wherein the network slice requirement information is used to indicate that a network resource of a first network slice needs to be updated to a first network resource;
sending, by the second network device, a first update request message to a first network device, wherein the first update request message carries the network slice requirement information;
receiving, by the second network device, an update acknowledgement message sent by the first network device based on the first update request message, wherein the update acknowledgement message is used to update the network resource of the first network slice based on the second network resource; and
updating, by the second network device, the network resource of the first network slice to the second network resource based on the update acknowledgement message.

7. The method according to claim 6, wherein the determining, by the second network device, network slice requirement information comprises:
receiving, by the second network device, a second update request message, wherein the second update request message carries service requirement information of a user; and
determining, by the second network device, the network slice requirement information based on the service requirement information.

8. The method according to claim 6, wherein the determining, by the second network device, the network slice requirement information comprises:
receiving, by the second network device, a third update request message sent by a third network device, wherein the third update request message carries the network slice requirement information; and
determining, by the second network device, the network slice requirement information based on the third update request message.

9. The method according to claim 6, wherein after the sending, by the second network device, the first update request message to the first network device and before the updating, by the second network device, the network resource of the first network slice to the second network resource based on the update acknowledgement message, the method further comprises:
receiving, by the second network device, a resource acknowledgement message sent by the first network device, wherein the resource acknowledgement message carries information about the second network resource; and
sending, by the second network device, a resource accept message to the first network device when the second network device determines to accept updating of the network resource of the first network slice to the second network resource, wherein the resource accept message is used to indicate that updating of the network resource of the first network slice to the second network resource is accepted.

10. The method according to claim 6, wherein after the updating, by the second network device, the network resource of the first network slice based on the update acknowledgement message, the method further comprises:
sending, by the second network device, information about the first network slice to a fourth network device, wherein the information comprises the information about the second network resource.

11. An apparatus for managing a network slice, comprising:
a transceiver,
a memory, configured to store instructions; and
a processor, coupled to the memory and the transceiver, and configured to execute the instructions stored in the memory, to perform operations comprising:
receiving, by using the transceiver, a reservation request message sent by a first network device, wherein the reservation request message carries information about a first network resource required by a first network slice;
reserving a second network resource based on the reservation request message received by the transceiver; and
sending, by using the transceiver, a reservation acknowledgement message to the first network device, wherein the reservation acknowledgement message carries information about the second network resource and is used to update a network resource of the first network slice to the second network resource.

12. The apparatus according to claim 11, wherein the transceiver is further configured to:
after sending the reservation acknowledgement message to the first network device, receive a configuration request message sent by the first network device, wherein the configuration request message carries the information about the second network resource;
wherein the processor is further configured to:
configure an association relationship between a network function of the first network slice and the second network resource based on the configuration request message; and
wherein the transceiver is further configured to:
send a configuration acknowledgement message to the first network device.

13. The apparatus according to claim 11, wherein the transceiver is further configured to:
after sending the reservation acknowledgement message to the first network device, receive a release request message sent by the first network device, wherein the release request message is used to request to release the second network resource;
wherein the processor is further configured to:
release the second network resource based on the release request message; and
wherein the transceiver is further configured to:
send a release acknowledgement message to the first network device.

14. The apparatus according to claim 11, wherein the processor is further configured to: after the reservation acknowledgement message is sent to the first network device, update information about the first network slice, wherein the information comprises the information about the second network resource.
